(19) United States
(12) Patent Application Publication
(10) Pub. No.: US 2011/0316977 A1
(43) Pub. Date: Dec. 29, 2011

(54) METHOD OF CNC PROFILE CUTTING PROGRAM MANIPULATION

(76) Inventor: Marius G. PIENAAR, Maineville, OH (US)

(21) Appl. No.: 13/168,384

(22) Filed: Jun. 24, 2011

Related U.S. Application Data
(60) Provisional application No. 61/398,245, filed on Jun. 24, 2010.

(51) Int. Cl. H04N 7/18; H04N 13/02

(52) U.S. Cl. 348/46; 348/86; 348/94; 348/E13.074; 348/E07.085

(57) ABSTRACT

A method of CNC program file cutting manipulation. The CNC imaging system comprises a capture device and a bed located below the capture device, wherein the bed has at least two reference points affixed thereto. A cutting head is mounted above the bed, and a controller controls movement of the cutting head. An image processing device communicates with the capture device and with the controller.

### CROSS-REFERENCE TO RELATED APPLICATION

This application claims the benefit of U.S. Provisional Application No. 61/398,245, filed on Jun. 24, 2010, the disclosure of which is incorporated herein by reference.

### FIELD OF THE INVENTION

This invention relates generally to an apparatus for an imaging system for capturing an image of a raw material plate. More particularly, this invention relates to an image capturing device and a method for manipulating CNC program cutting plans to fit a raw material plate edge boundary.

### BACKGROUND

Computer numerical control refers generally to the automation of machine tools that are operated by abstractly programmed commands encoded on a storage medium. In modern CNC systems, end-to-end component design is highly automated using Computer Aided Design and Computer Aided Manufacturing (CAD/CAM) programs. The programs produce a computer file that is interpreted to extract commands that are needed to operate a particular machine via a post processor. The computer file is typically referred to as a “CNC program”, and it is this program that contains all the commands needed for a CNC profile cutting machine to produce accurate parts from a flat sheet of raw material.

Pixel definition: In digital imaging, a pixel or picture element is a single point in a raster image. The pixel is the smallest addressable screen element; it is the smallest unit of picture that can be controlled. Each pixel has its own address which corresponds to its coordinates in a two dimensional grid.

Historically, cutting machines have been controlled via hand wheels or levers, or mechanically automated via cams alone. With CNC profile cutting machines the cutting head(s) of the machine is/are operated by a two-axis gantry drive system mounted above a flat cutting table. The most common cutting heads for CNC profile cutting utilize oxy-fuel, plasma, laser, router or water jet cutting heads. Typically, the cutting head is positioned at the machine-zero reference point, which is generally in one of the four corners of the cutting bed, and the operator selects the desired CNC program and loads it into the CNC controller. The raw material, typically any material that presents itself in sheets or plates, is positioned flat on the cutting bed and the desired parts are cut-out by the cutting heads according to the dictates of the CNC program.

The raw material size is not consistent and loading it onto the machine bed can be difficult due to size and weight. It is also difficult to align the material reference corner and edge with that of the machine's zero reference and machine X travel axis. Due to the likelihood of miss-alignment during loading, the CNC program will sometimes cut off the material resulting in scrapped parts and lost production. To counter this issue, the CNC program is normally run on the machine in a dry run mode, where all the machine movement occurs but no cutting is performed. During the dry run, the machine operator has to watch the cutting heads move to make sure that they never go off the raw material and thus ensure that the CNC program will fit the raw material at its current position and orientation. The dry run is very time consuming, especially if the CNC program did not fit and the program needed adjustment through translation and/or rotation, and then tested again.

### SUMMARY OF THE INVENTION

This invention relates to a CNC imaging system comprising a capture device, a bed located below the capture device, wherein the bed has at least two reference points affixed thereto, a cutting head mounted above the bed, a controller for controlling movement of the cutting head, and an image processing device communicating with the capture device and with the controller.

This invention further relates to a method for CNC imaging comprising providing a capture device, providing a bed with at least two reference points affixed thereto, capturing an image with the capture device of a raw material plate located on the bed, processing the image with an image processing device, and comparing the processed image with a CNC program cutting plan.

This invention further relates to a CNC scanning system comprising a bed, a frame, at least a portion of which is positioned above the bed, a capture device affixed to the frame, a measuring apparatus affixed to the frame for measuring a location of the frame, and an image processing device communicating with the capture device, wherein the image processing device utilizes software to detect an edge of a raw material plate from data captured by the capture device.

This invention further relates to a method of processing captured data comprising capturing at least one set of data of a raw material plate located on a bed with a capture device affixed to a frame, measuring a location of the frame to provide the location for each set of data, processing each set of data to calculate a raw material plate edge boundary, loading a CNC program having a CNC program cutting plan, comparing the CNC program cutting plan with the raw material plate edge boundary, and assessing whether the CNC program cutting plan fits within the raw material plate edge boundary.

### BRIEF DESCRIPTION OF THE DRAWINGS

FIG. 1 is a schematic depiction of the disclosed method of cutting pieces or parts from a flat sheet of raw material using a computer numerical controlled (CNC) profile cutting machine.

FIG. 2 is a perspective view of an embodiment of a plate scanner system of the invention.

FIG. 3 is a perspective view of a visual scan space indicator of the invention.

FIG. 4 is another perspective view of an embodiment of a plate scanner system of the invention.

FIG. 5A is an image display device showing a plate edge boundary.

FIG. 5B is an image display device showing a CNC program cutting plan superimposed over a plate edge boundary.

FIG. 5C is image display device showing an adjusted CNC program cutting plan superimposed over a plate edge boundary.

FIG. 6 is a top view of a raw material plate located on a bed.

FIG. 7 is a top view of a CNC program cutting plan with a crop line superimposed on a raw material plate.

FIG. 8A is a top view of another CNC program cutting plan superimposed on a portion of a raw material plate.

FIG. 8B is a top view of a renested CNC program cutting plan superimposed on a portion of a raw material plate.

### DETAILED DESCRIPTION OF THE INVENTION

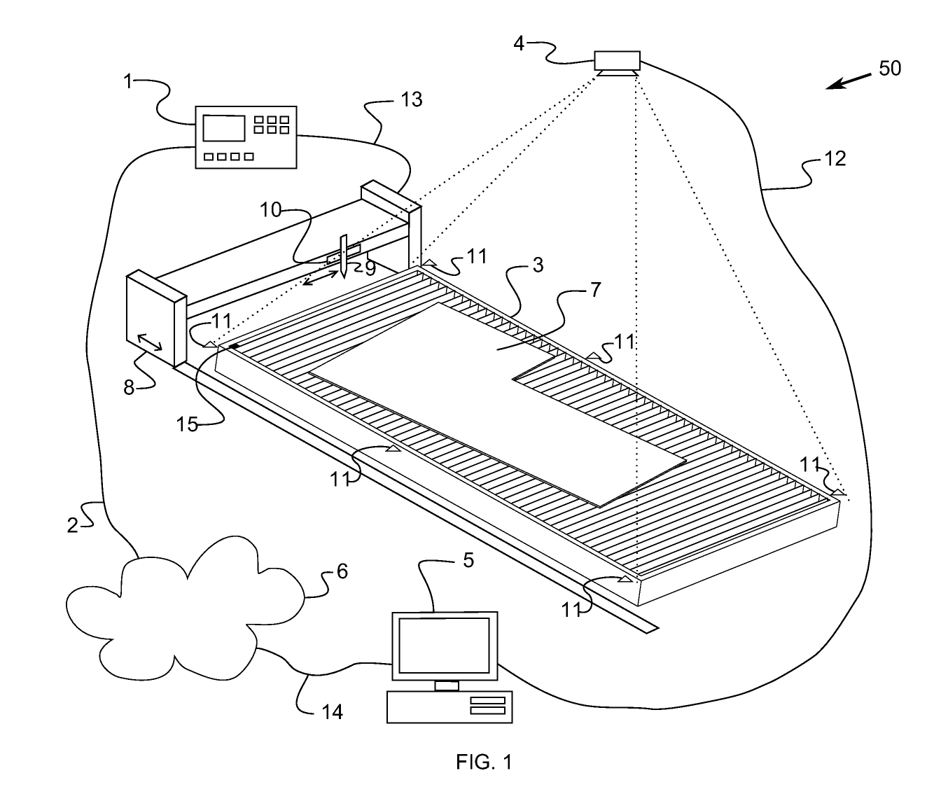

The disclosed method is best described by frequent reference to the drawing. In gross, FIG. 1 depicts elements employed in the disclosed method. FIG. 1 shows one embodiment of the invention, a CNC imaging system 50.

Raw material 7, typically in sheet form, is placed on the cutting bed 3 of the machine, and the operator inputs basic information such as material thickness and cutting head 9 information (# of and spacing) into the computer 5. There can be more than one piece of raw material to process. An image of the raw material on the cutting bed is captured digitally with capture device 4, which is a generic designation for a device such as a digital camera, digital scanner, laser scanner or ultrasound scanner. And, of course, there could be multiple capture devices to produce a composite digital image. The digital image, regardless of method of capture, is sent to the computer 5, either by cable or wireless communication 12 (electronic communication).

The digitally captured image is converted to a visible image by the software and displayed. The operator confirms that the captured image represents the raw material on the cutting bed. Any distortion in the image due to technical limitations of the capture device, such as wide angle lens distortion or other limitations, can be remedied routinely at this juncture in the process.

The machine bed is fitted with several distinguishable reference points 11 of known static locations or positions. These reference points will also be captured during the image capturing event, and software will automatically recognize and record their locations for future use. The software also automatically calculates an “image scaling factor” by comparing the recognized reference points in the image to the known static reference points 11. This “factor” determines the ratio between image size and in pixels and “real world” size. This “scaling factor” value is expressed in pixels per inch (PPI).

The software also calculates automatically the image “machine zero reference” by comparing the recognized capture reference points in the image to the known static reference points 11. The distance from the machine zero reference 15 to the known reference points 11 in the “real world” is known, and, by means of the PPI, the “machine zero reference” of the captured image is determined. This determination is important because the capture device 4 may have moved slightly as a result of accidental movement or even temperature fluctuations. The image “machine zero reference” is displayed on the computer screen so that the operator can confirm the correct zero position.

The raw material boundary is recognized by means of applying edge detection techniques in the software. Edge detection can be accomplished in various ways and some of the techniques will include thresholding, Sobel, homogeneity and difference edge detection algorithms. All these methods rely on traversing the image at the pixel level for the purpose of edge detection.

The edge data detected by any of the foregoing methods is represented as vectors by means of curve fitting and smoothing algorithms. Curve fitting is the process of constructing a curve, or mathematical function that has the best fit to a series of data points, possibly subject to contrasts. Curve fitting can involve either interpolation, where an exact fit to the data is required, or smoothing, in which a “smooth” function is constructed that approximates the data. Vectors will consist of line and arc vector data.

The software combines the vector data so that it creates a closed contour boundary that represents the edge or periphery of the raw material image. The software verifies that the contour representation of the raw material edge is closed and will notify the operator if they are not. The closed contours of the patterns are superimposed over the captured image for operator verification, and the software will zoom in, moving along a detected edge contour at a designated speed so that the operator can visually verify that the detected contour edge corresponds to that of the raw material.

The operator can also manipulate, add or remove vectors as necessary in order to correct edge vectors.

The image of a raw material plate may also be considered a picture of the raw material plate with no vectors defining the raw material plate edge boundary. In that case, no edge detection has occurred, and the operator may visually assess whether the CNC cutting plan fits within the image of the raw material plate.

Currently, the available CNC programs reside in a common data location 6. This “location” can be a local or network drive, and the computer 5 is in electronic communication 14 by either cable or wireless network (electronic communication).

The contents of the CNC program are interpreted and converted to vector line and arc data. The vector data is scale based on the calculated PPI so that the scale is that of the captured image. The CNC vector data are translated so that its zero reference is the same as the image “machine zero reference”.

The operator translates and rotates the CNC vector data, and the effect of the transformation is displayed on the computer 5 screen so that the operator gets instant visual feedback as to whether or not the CNC program will fit the raw material. It is apparent at this juncture in development of the process that the translating and rotating can be automated.

The software also allows the operator to manipulate the display image so that some of the data can be hidden. For instance, the captured image of the raw material can be turned off while displaying only the CNC and raw material contours.

In addition to the foregoing, the software deployed in the disclosed process will enable panning and zooming in and out of the viewable image. It will verify that all CNC data is within the boundary of the raw material and will alert the operator if certain edge margin requirements are not met.

The software will create a new CNC program that reflects the translation and rotation activities of the CNC vector data in the software. The new CNC program is saved to the common data location 6 via electronic communication 14.

The CNC controller 1 can load the new CNC program by means of cable or wireless communication 2 (electronic communication) and run the program by means of cable communication 13 which drives gantry X-axis movement 8 and Y-axis movement 10, thereby moving the cutting head 9.

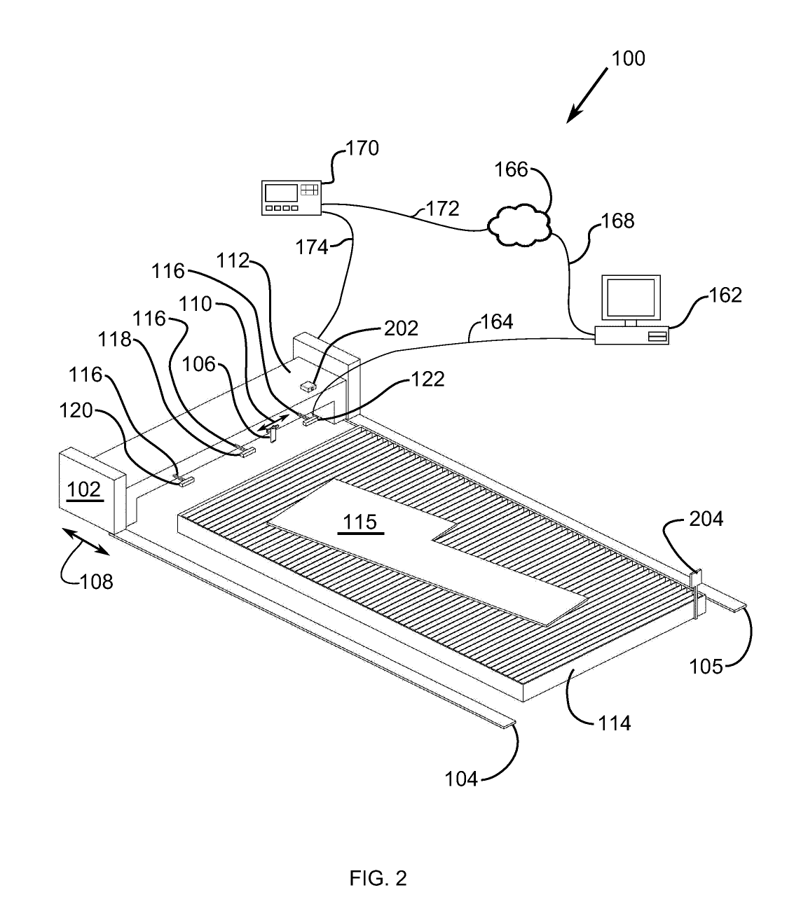

FIG. 2 shows another embodiment of the invention, a CNC scanning system 100. The CNC scanning system 100 has a frame 102 that rides on rails 104 and 105. The frame is movable in the x direction as depicted by arrow 108. A cutter 106, which may be a plasma cutter, a laser cutter, an oxygen acetylene cutter, or other type of cutter, is affixed to the frame 102. The cutter 106 is movable along the frame in the y direction, as depicted by arrow 110. Located below an upper beam 112 of the frame is a bed 114.

Affixed to the frame are holders 116 for holding capture devices 118, 120, and 122. Alternatively, one holder could be used to hold the capture devices or the capture devices could be attached directly to the frame. One, two, three, or more capture devices may be used. The capture devices can be digital cameras, digital scanners, laser scanners, ultrasonic scanners, or other types of devices used to capture data. In one example, the capture devices are 3D scanners. Some examples of 3D scanners are described in Metcalfe et al, U.S. Pat. No. 7,525,114 ('114), Metcalfe et al U.S. Pat. No. 6,618,155 ('155), Metcalfe et al, U.S. Pat. No. 6,825,936 ('936) and in Freedman, U.S. Pub. No. 2010/0290698 ('698), which are incorporated by reference in their entirety. Some of the capture devices utilize a light source, such as a laser, to project light onto the raw material plate. One example of a 3D scanner described in the '698 publication projects a pattern of light onto an object, and the capture device captures the image of the light on the object as data. That captured data may be referred to as a point cloud.

The bed 114 is a cutting bed typical of the type used to hold raw material plates while they are cut, but other types of beds may also be used. For example, if a CNC scanning system uses a frame and bed exclusively for scanning, then a dedicated scanning bed could be used to hold the raw material plate. Various types of frames may be used. In one example, the frame is a gantry, but the frame could also be a cantilever beam or other support device for holding the capture device. Typically, at least one portion of the frame is above the bed.

A measuring apparatus 202 measures the location of the frame 102 along the bed 114. The location of the frame at the time when data or sets of data (described later) are captured is used by the image processing device to build the full image of a raw material plate 115 from the captured data or sets of data. In one example, the measuring apparatus 202 is a laser and a reflected laser beam receiver. The laser projects a beam to a reflector 204, which reflects the beam back to the laser beam receiver. Other measuring devices may also be used to determine the location of the frame 102 along the bed 114. For instance, the measuring device could be an ultrasonic measuring device, an encoder riding on the rail 104 or an encoder riding on the rail 105. Additionally, the location of the frame could be determined by utilizing measuring devices that are integral with the cutting system and are typically used by the cutting system to ascertain the location of the frame during the cutting process, such as an integral encoder.

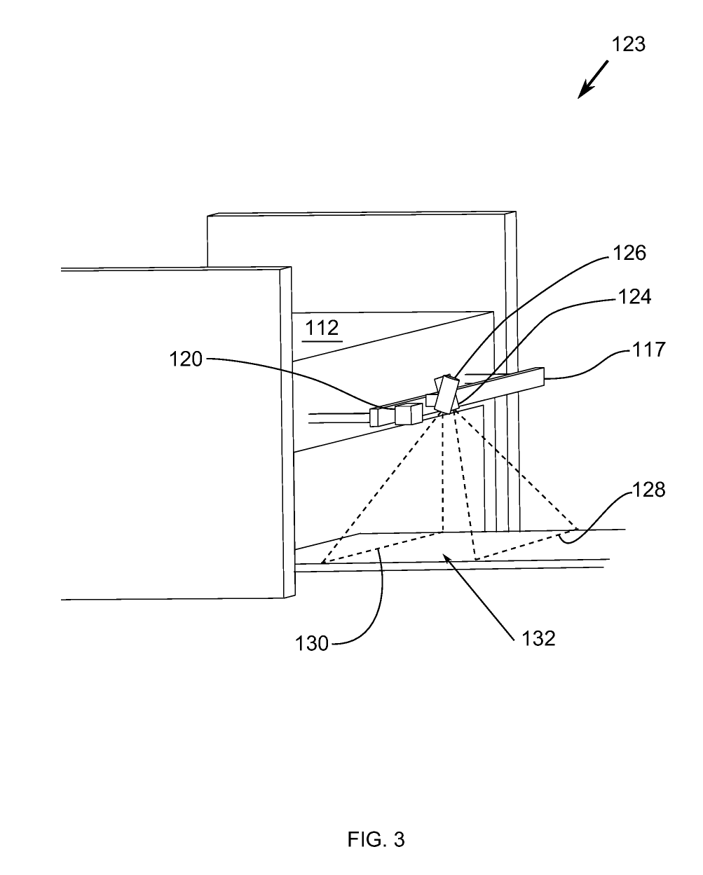

As shown in FIG. 3, the holder can also have visual scan space indicator 123 having a first laser 124 and a second laser 126 affixed to a holder 117. The first laser 124 projects a forward visible beam 128 and the second laser 126 projects a rearward visible beam 130. Typically, the forward visible beam 128 and the rearward visible beam 130 are approximately parallel to the beam 112. The visible beams 128 and 130 allow an operator to observe a scanning area 132 between the beams where the capture device is capturing data. Because the light from the light source utilized by the 3D scanners is typically invisible to the human eye, a visible laser beams assist an operator in assessing where the 3D scanners are operating. Alternatively, the lasers may be affixed to the upper beam 112 or to another apparatus.

Referring back to FIG. 2, the CNC scanning system 100 has a computer 162 for receiving scanned data or sets of data from the capture devices 118, 120, and 122 through an electronic communication link 164. The electronic communication link 164 can be a cable or a wireless mechanism. A data location 166 stores CNC programs used for cutting raw material plates. The data location 166 can be a local or network drive, and the data location is connected typically to the computer 162 by an electronic communication link 168 and to a CNC controller 170 by an electronic communication link 172. The electronic communication links 168 and 172 may be cable or they may be wireless. Additionally, the data location 166 may be a part of the computer 162. The controller 170 is connected typically to the frame 102 and the cutter 106 by an electronic communication link 174. The electronic communication link 174 may be cable or it may be wireless. Alternatively, the computer 162 and the controller 170 may be a single device, the controller 170 and the data location 166 may be a single device, or the computer 162, the controller 170, and the data location 166 may be a single device.

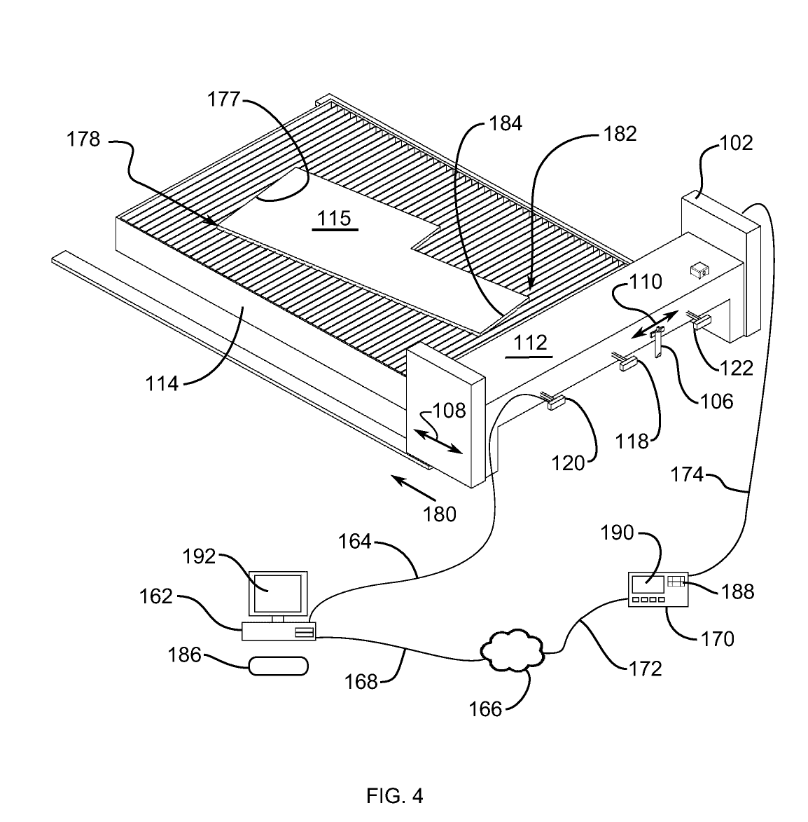

FIG. 4 depicts a typical operation of the plate scanner system. Other methods and operations may also be used to accomplish the same results, and the methods and operations presented here are only representative of embodiments envisioned to be covered by this patent.

First, an operator determines the end of the raw material plate where the cutting operation will start. Typically, the CNC program cutting start location is on a first end 177 at a lower left corner 178, known as the plate home zero, of a raw material plate 115. But the cutting start location could be at another end or corner. The operator then typically drives the frame 102 to an end opposite the cutting start location, so that when the scan is completed the frame is at the cutting start location, thereby saving the operator the time it would take to move the frame back to the cutting start location. The cutter is moved by the CNC controller via the frame 102 and the beam 112 in the directions of arrows 108 and 110. Typically, the frame is driven by motors controlled by the CNC controller 170, but other methods of driving the frame may also be used. For example, if the plate scanning system is a dedicated plate scanning system, then the controller could be a controller independent of the CNC controller. At this time, the raw material plate 115 has been loaded onto the bed 114. The frame is then moved in the direction of arrow 180 to the scanner start view area 182 located at a second end 184 of the plate 115. Typically, the frame is moved by way of instructions entered on an input device 186 located on the controller 170. For example, the input device may have a soft key for moving the frame in the direction of arrow 180. Alternatively, the computer may be configured so the frame can be controlled through inputs to the computer 162. Typically, the controller would also have a display 190 for providing information to the operator.

Using the input device 186, which can be a mouse, a keyboard, touch screen, an electronic pen, or other type of input device, attached to the computer 162, the user inputs the raw material plate thickness and cutting head quantity, spacing, and other necessary information. Alternatively, the CNC file may contain some or all of that information, thereby limiting the amount of information the operator is required to input. The visual scan space indicator 123 displays visible beams 128 and 130 on the raw material plate 115 so the operator knows where the capture device is scanning The operator positions the frame so that the second end 184 of the plate is between the display beams 128 and 130. The operator then starts the scanning by way of the input device 186. The frame travels in the direction of arrow 180 while the capture devices 118, 120, and 122 scan the raw material plate 115. Data from the capture devices is received by the computer 162 through the electronic communication link 164. When the first end 177 of the plate is between the visible beams 128 and 130, the operator stops the frame, as the scanning is complete.

The computer runs image processing software to process the captured scan data. One method by which the software processes the scan data is disclosed in '698 U.S. Patent publication. The capture device may include the imaging processing software, in which case the capture device would send processed data to the computer. Or the capture device may send raw data to the computer, in which case the computer would include the image processing software. Using 3D mapping and edge detection techniques, a map of the raw material plate is constructed defining the raw material plate edge boundary as vectors. More than one plate can be scanned during a pass of the frame, and the user can select an active plate using the input device 186.

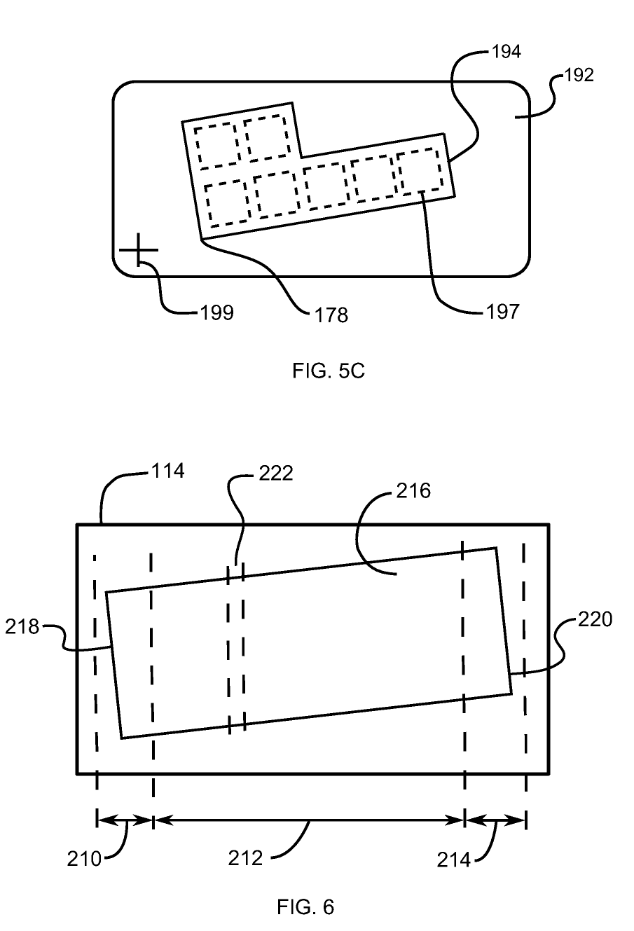

Typically, the frame will move at between 0 and 200 inches per second, more typically between 0 and 100 inches per second, and most typically between 0 and 50 inches per second. To limit the amount of data to be analyzed, the image processing device may be programmed to analyze only a portion of the data obtained from the scan. FIG. 6 shows a raw material plate 216 located on the bed 114 with areas 210, 212, and 214. In the areas 210 and 214, the image processing device would typically analyze much of the data captured by the capture device to correctly define ends 218 and 220 of the raw material plate. In the area 212, typically only slivers of data, as shown by representative subarea 222 may be analyzed. Typically, multiple slivers of data, each sliver adjacent to another, would be analyzed. The data captured at the one end may be referred to as a set of data and a sliver of data may be referred to as a set of data.

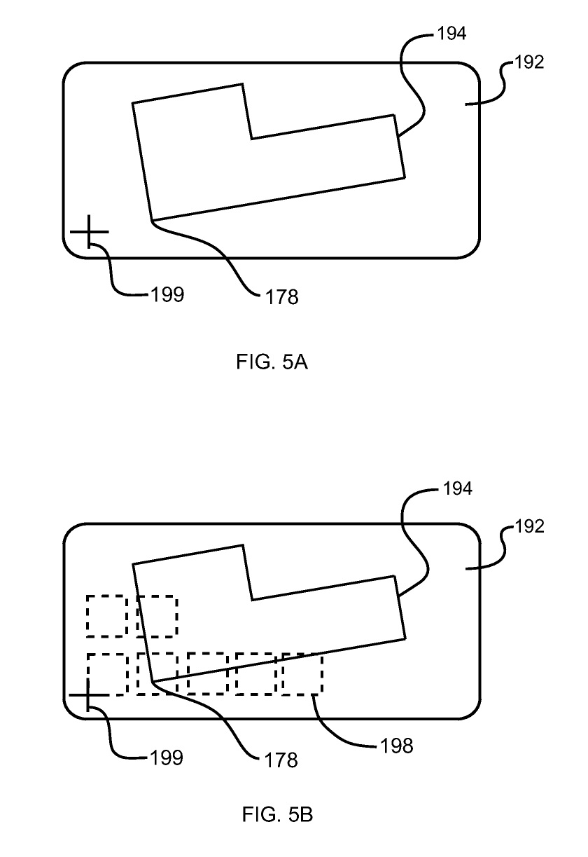

By analyzing the data captured in the areas 210 and 214 and the slivers of data between the areas 210 and 214, the image processor calculates the raw material boundary and defines that boundary by vectors. The vectors can be used to display a raw material plate edge boundary. FIG. 5A depicts the raw material plate edge boundary 194 and plate home zero 178 on the image display device 192 communicating with the computer 162. The image display device 192 may also show the machine zero reference 199. In FIG. 5A, the displayed raw material plate boundary is a vectorized image of the raw material plate boundary.

The user then selects a CNC program from the data location 166 and loads the file into the computer 162. The contents of the CNC program are interpreted and converted to vector line and arc data so that the CNC program cutting plan 198 can be displayed on image display device 192. For illustrative purposes, the CNC program cutting plan 198 is represented by dashed lines. The selected CNC program cutting plan 198 is displayed relative to the raw material plate edge boundary 194 and superimposed over the raw material plate edge boundary 194. FIG. 5B depicts the unmodified CNC program cutting plan as it would cut if no adjustments were made.

With the raw material plate boundary defined by vectors, the computer may automatically analyze whether the CNC program cutting plan fits within the raw material plate boundary. If the cutting plan can be made to fit within the raw material plate edge boundary 194, then the computer software automatically manipulates the CNC program cutting plan 198 through translation and rotation to fit within the raw material plate edge boundary 194. FIG. 5C depicts the modified CNC program cutting plan 197 that fits inside the raw material plate edge boundary 194.

Alternatively to displaying the raw material plate edge boundary 194 and the CNC program cutting plan 198, the computer software may automatically manipulate the CNC program cutting plan 198 through translation and rotation to fit within the raw material plate edge boundary 194. With the automatic manipulation, an image display device for an operator may be omitted.

Instead of the computer software automatically manipulating the CNC program cutting plan 198, an operator may manually manipulate the CNC program cutting plan 198 by visually comparing the CNC program cutting plan 198 with the raw material plate edge boundary 194. Various methods of manually manipulating the CNC program cutting plan 198 could be used. For example, the operator may use an input device 186 such as a mouse or keyboard arrow keys to move the cutting plan in the x or y direction, or the operator could key in distances, in inches for example, to move the cutting plan in the x or y direction. The translated image is then displayed on the screen superimposed over the raw material plate edge boundary 194. And the distance the CNC program cutting plan has moved in the x and y direction may be displayed.

The operator may also rotate the CNC program cutting plan 198. Manual rotation can be completed by various methods. For example, the operator may use an input device 186 such as a mouse to rotate the cutting plan clockwise or counterclockwise, or the operator could key in an angle, a positive angle for clockwise rotation and a negative angle for counterclockwise rotation, or the operator could use the Ctrl-Left Arrow or Ctrl-Right Arrow. The rotated image is then displayed on the screen superimposed over the plate edge boundary 194. And the angle of rotation of the cutting plan may also be displayed.

To manually check that the cutting plan fits within the plate edge boundary, the operator may pan and zoom in on the display. The panning and zooming may be accomplished by way of a mouse or other input device.

To verify that the adjusted CNC code is correct, a verification step may be included. With a verification step, after the operator is satisfied that the cutting plan fits within the plate edge boundary, the operator selects a Verify button on the computer 162. The computer then exports the adjusted CNC program to the data location 166, and then imports the adjusted CNC program to the computer. The imported adjusted CNC program is checked against the raw material plate edge boundary to ensure that the cutting plan of the adjusted CNC program fits within the raw material plate edge boundary. As before, an operator can check the profile visually. If the adjusted CNC program cutting plan needs further manipulation to fit within the raw material plate edge boundary, then the adjusted CNC program cutting plan is discarded, the operator continues manipulation of the original CNC program, and again saves the manipulated CNC program as an adjusted CNC program. The verification step can then be repeated until the operator is satisfied with the manipulation. This verification step may be performed automatically or by a computer.

After verifying that the adjusted CNC program cutting plan will fit within the raw material plate edge boundary, the operator selects a Commit button to close the session. The software will move the original CNC program to a “complete folder” and send the adjusted CNC program to a data location communicating with the controller for production.

After completing the verification step, the operator uses the adjusted CNC program to begin cutting the raw material plate. The software can be configured to provide the adjusted CNC program relative to the plate home zero 178 or relative to the machine zero reference 199. The software provides the coordinates of the plate home zero 178 to the operator, and the operator then drives the cutter to plate home zero. Alternatively the software provides the coordinates of the plate home zero to the controller, which drives the cutter to plate home zero. After verifying that the cutter is at plate home zero, the operator starts the raw material plate cutting operation.

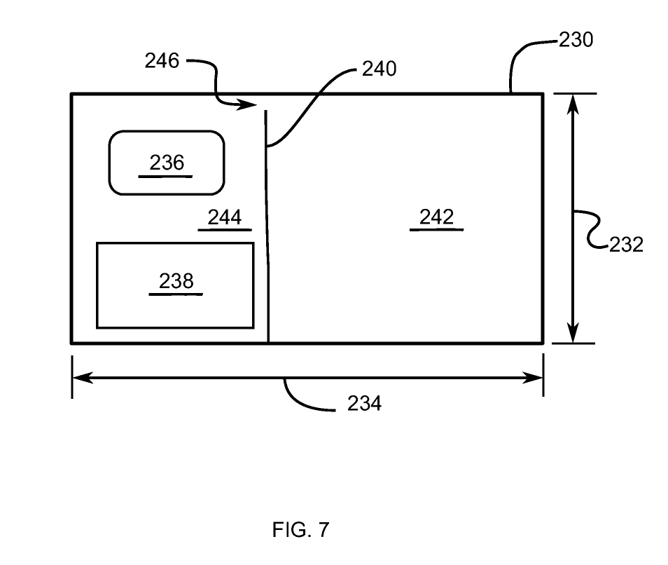

The computer software may be used to not only manipulate the CNC program by translation and rotation, but also to manipulate individual CNC commands to fit the raw material plate boundary. FIG. 7 shows a raw material plate 230 having a width 232 and a length 234. A typical nominal standard width is 96″ and a typical nominal standard length is 240″, but the width and length could be any typical nominal mill dimension. And typically a plate with a nominal dimension of 96″×240″ will actually measure larger, for instance 98″×244″. FIG. 7 also shows a typical CNC program for cutting objects 236 and 238 out of a portion of the raw material plate. A cut line 240 is included in the original CNC program to cut the remnant 242 from the scrap 244 so the remnant can be later used. As programmed for a nominal dimension of 96″, the cut line is a distance 246 short of cutting the full width of the plate, because the actual plate width is 98″. If the CNC program is not adjusted to compensate for the added distance 246, then a torch operator would have to manually cut the distance 246 to complete the cut across the plate. Using the captured image of the raw material plate, the CNC program can be compared to the raw material plate edge boundary and adjusted so the cut line 240 passes the full width of the plate 230. The CNC program adjustment can be made manually by an operator or automatically by the computer and computer software.

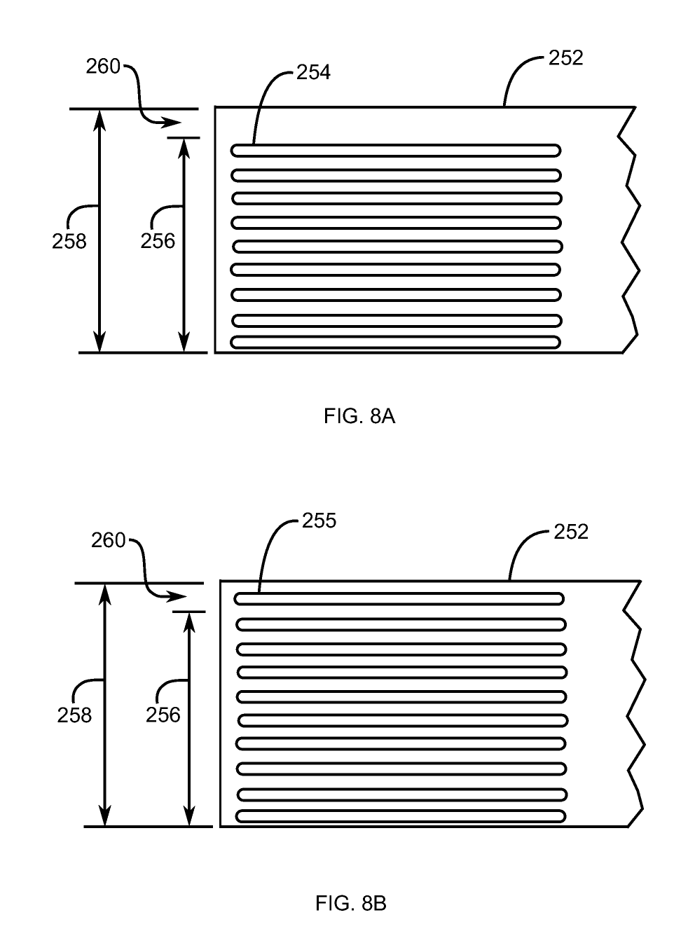

FIGS. 8A and 8B depict another case where manipulation of the CNC code beyond translation and rotation is useful. FIG. 8A depicts the original CNC cutting plan for a plurality of pieces 254 from a raw material plate 252 having a nominal width 256 and an actual width 258. The actual width 258 is greater than the nominal width by a distance 260. Using the raw material plate edge boundary, the CNC program cutting plan can be renested to maximize the usage of the raw material plate. FIG. 8B shows the CNC program cutting plan renested, whereby an additional piece 255 was able to be cut from the raw material plate 252.

While many steps, actions, processes, and operations described herein are described as being performed by an operator, they may also be performed automatically by a device such as a computer, and fall within the scope of this patent and description herein.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

What is claimed is:

1. A CNC imaging system comprising:
a capture device,
a bed located below the capture device, wherein the bed has at least two reference points affixed thereto,
a cutting head mounted above the bed,
a controller for controlling movement of the cutting head, and
an image processing device communicating with the capture device and with the controller.

2. The CNC imaging system according to claim 1, further comprising an image display device communicating with the image processing device.

3. The CNC imaging system according to claim 2, wherein the image processing device utilizes software to detect an edge of a raw material plate imaged by the capture device and to display a raw material plate boundary on the image display device.

4. The CNC imaging system according to claim 2, wherein the image display device displays an image of a raw material plate boundary and a CNC program cutting plan superimposed on the image of the raw material plate boundary.

5. A method for CNC imaging comprising:
providing a capture device,
providing a bed with at least two reference points affixed thereto,
capturing an image with the capture device of a raw material plate located on the bed,
processing the image with an image processing device, and
comparing the processed image with a CNC program cutting plan.

6. The method according to claim 5, further comprising displaying an image of the raw material plate on an image display device.

7. The method according to claim 5, further comprising defining a raw material plate boundary by detecting an edge of the raw material plate with the image processing device.

8. The method according to claim 6, further comprising displaying a cutting plan superimposed on the image of the raw material plate.

9. The method according to claim 6, further comprising the step of manipulating the CNC program to fit a CNC program cutting plan within the image of the raw material plate to create an adjusted CNC program.

10. The method according to claim 9, further comprising the step of storing the adjusted CNC program to a data location.

11. The method according to claim 10, further comprising the step of verifying that the adjusted CNC program cutting plan fits within the image of the raw material plate by uploading the stored adjusted CNC program and comparing an adjusted CNC program cutting plan with the image of the raw material plate.

12. The method according to claim 11, wherein the manipulating step is performed automatically by a computer.

13. The method according to claim 11, wherein the step of verifying is performed by an operator visually comparing the adjusted CNC program cutting plan with a raw material plate edge boundary.

14. The method according to claim 11, wherein the step of verifying is performed automatically by a computer.

15. A CNC scanning system comprising:
a bed,
a frame, at least a portion of which is positioned above the bed,
a capture device affixed to the frame,
a measuring apparatus affixed to the frame for measuring a location of the frame, and
an image processing device communicating with the capture device, wherein the image processing device utilizes software to detect an edge of a raw material plate from data captured by the capture device.

16. The CNC scanning system according to claim 15, further comprising an image display device, wherein a raw material plate edge boundary is displayed on the image display device.

17. The CNC scanning system according to claim 15, wherein the measuring apparatus is a measuring apparatus from the group consisting of an ultrasonic measuring apparatus, an integral machine encoder, an encoder, and a laser measuring apparatus.

18. The CNC scanning system according to claim 15, wherein the capture device is a 3D scanner.

19. The CNC scanning system according to claim 15, further comprising a light source positioned above the raw material plate for projecting light onto the raw material plate.

20. The CNC scanning system according to claim 15, further comprising a visible laser affixed to the frame for visually identifying a scanning area.

21. A method of processing captured data comprising:
capturing at least one set of data of a raw material plate located on a bed with a capture device affixed to a frame,
measuring a location of the frame to provide the location for each set of data,
processing each set of data to calculate a raw material plate edge boundary,
loading a CNC program having a CNC program cutting plan,
comparing the CNC program cutting plan with the raw material plate edge boundary, and assessing whether the CNC program cutting plan fits within the raw material plate edge boundary.

22. The method according to claim 21, further comprising the step of displaying on an image display device the CNC program cutting plan superimposed on an image of the raw material plate edge boundary.

23. The method according to claim 21, further comprising the step of manipulating the CNC program to fit the CNC program cutting plan within the raw material plate edge boundary to create an adjusted CNC program.

24. The method according to claim 23, further comprising the step of storing the adjusted CNC program to a data location.

25. The method according to claim 23, wherein the manipulating step is performed automatically by a computer.

26. The method according to claim 24, further comprising the step of verifying that the adjusted CNC program cutting plan fits within the raw material plate edge boundary by uploading the stored adjusted CNC program and comparing an adjusted CNC program cutting plan with the raw material plate edge boundary.

27. The method according to claim 26, wherein the step of verifying is performed by an operator visually comparing the adjusted CNC program cutting plan with the raw material plate edge boundary.

28. The method according to claim 26, wherein the step of verifying is performed automatically by a computer.

29. The method according to claim 21, wherein the capturing step comprises capturing data with a 3D scanner.

30. The method according to claim 21, further comprising the step of providing a visible laser to identify a scanning area.

31. The method according to claim 21, further comprising the step of projecting a light source onto the raw material plate.

32. The method according to claim 21, further comprising the step of manipulating individual CNC commands to fit the raw material plate boundary.

33. The method according to claim 21, further comprising the step of renesting a CNC cutting plan to maximize the usage of a raw material plate.
